(19) United States
(12) Patent Application Publication
(10) Pub. No.: US 2016/0034743 A1
(43) Pub. Date: Feb. 4, 2016

(54) METHOD FOR REQUESTING IMAGES FROM EARTH-ORBITING SATELLITES

(71) Applicant: David Douglas Squires, Stockton, CA (US)

(72) Inventor: David Douglas Squires, Stockton, CA (US)

(21) Appl. No.: 14/752,296

(22) Filed: Jun. 26, 2015

Related U.S. Application Data
(60) Provisional application No. 62/030,256, filed on Jul. 29, 2014.

(51) Int. Cl. G06K 9/00; G06T 7/40; G06T 3/00; G06T 1/00; G06T 7/00

(52) U.S. Cl. CPC G06K 9/0063; G06T 1/0007; G06T 7/0044; G06T 3/0043; G06T 7/401; G06T 7/0087; G06T 7/0081; G06T 2207/10032; G06T 2207/30181; G06T 2207/30232; G06T 2210/61

(57) ABSTRACT

A method for consumer-direct requesting of images from an Earth-orbiting satellite system having online Earth and Space maps with image location selection tools. The consumer may select image from map, specify a desired image time or use a computer algorithm to match Earth or space coordinates. The consumer may place an order, send an order to computer database, and generate Earth or space pointing coordinates for satellite(s) selected to record the image. The system may automatically select a ground station in order to command, record, or transmit selected image from satellite. The system may store and/or retrieve selected image into computer database as well as deliver selected image to consumer.

### BRIEF DESCRIPTION OF THE DRAWINGS

FIG. 1 illustrates a flow chart of the steps of the method for requesting images from Earth-orbiting satellites according to the present invention.

FIG. 2 illustrates a flow chart which is a continuation of the flow chart of FIG. 1; and

FIG. 3 illustrates a flow chart which is a continuation of the flow chart of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a method for enabling customer-direct requesting of images from earth-orbiting satellites and quickly providing the images to the customer.

The method for requesting images from earth-orbiting satellites comprises the steps of: selecting an image option from a map; placing an order; sending the order to a computer database; finding earth or space coordinates for the selected image; using a computer algorithm to match the earth or space coordinates of the selected image with a ground track of the satellite; transmitting the selected image from the satellite to the ground; storing the selected image into a computer database; retrieving the selected image from this computer database; and delivering the selected image to the customer.

The current methods for acquiring satellite images are unable to take large numbers of orders placed directly by customers. In addition, these current methods rely on a small number of orbiting satellites and are thereby necessarily limited in the number of orders they can accommodate. Furthermore, the current methods require the consumer to have a great understanding about satellite capabilities, causing the ordering process to be cumbersome for routine image orders that would be made by an average consumer.

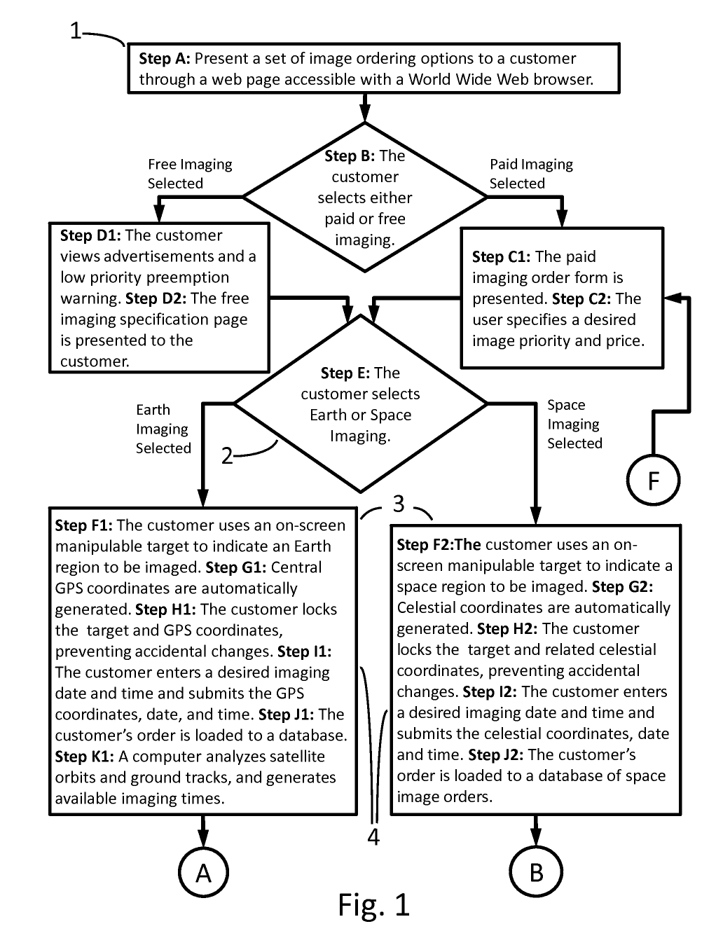

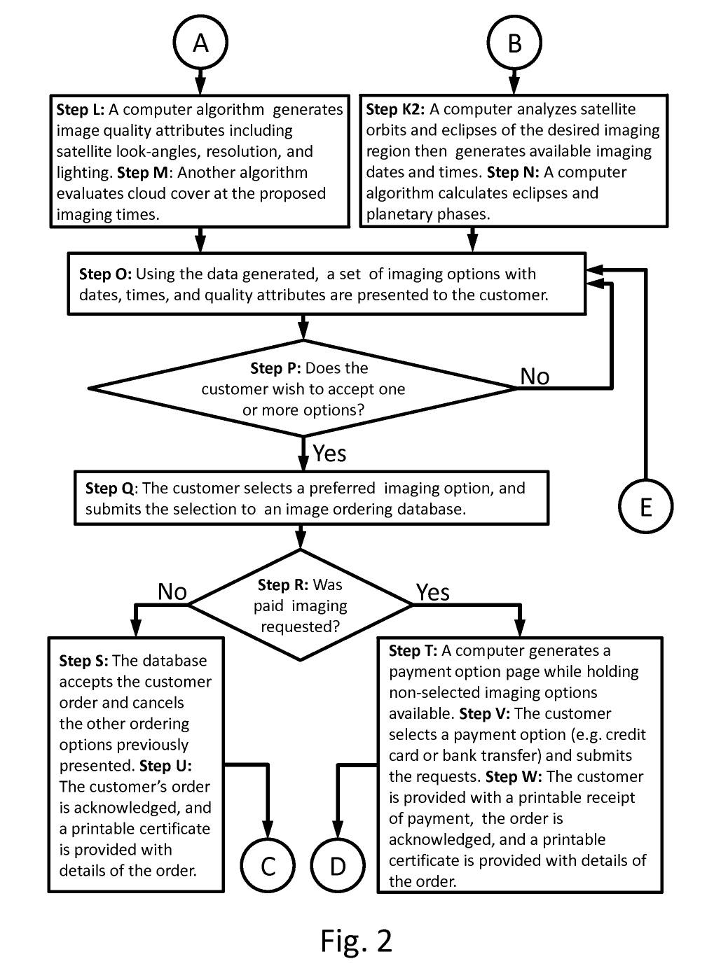

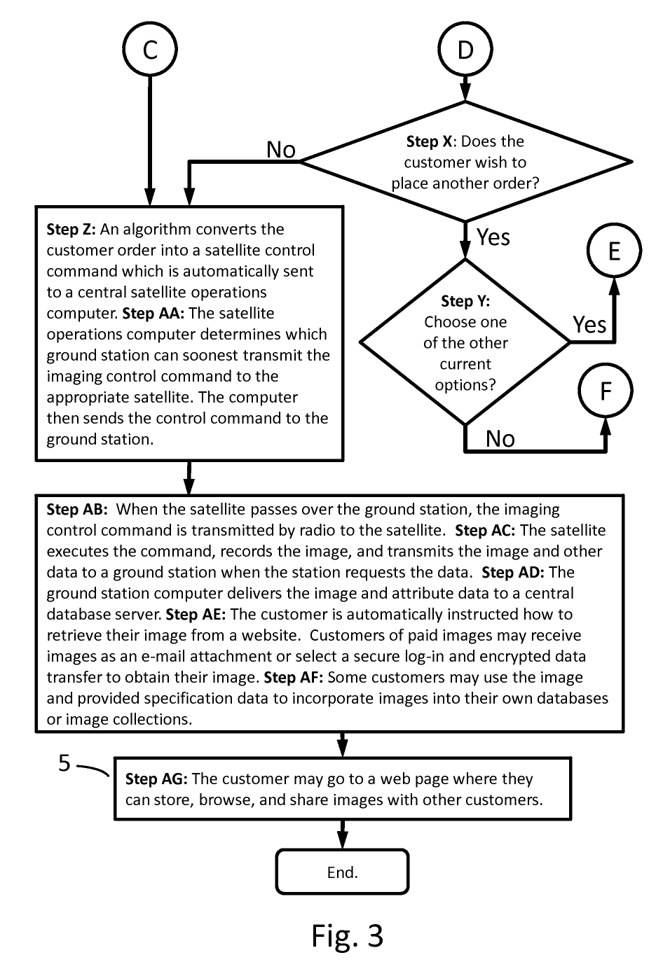

Steps of the method (See FIGS. 1-3):

In step A, a set of image ordering options may be presented to a customer through a web page. In step B, the customer may select to either pay for the images or receive free images. In steps C1 and C2, if the customer selected paying for the images, the paid imaging order form may be presented, image priority and pricing may be specified, and the customer proceeds to step E, otherwise continue with step D1. In step D1, if the customer selected receiving free images; they may be required to view some advertising and may be informed that their images may have lower priority than paid images. In step D2, the customer may be presented with the free imaging order form. In step E, the customer may choose from either Earth images or Space images. In step F1 or F2, the customer may be presented with an interactive map that may assist with selecting a region to be imaged. The customer may choose the region on the map for the desired image. In step G1 or G2, an algorithm may generate coordinates for the selected region. In steps H1 and H2, the customer may confirm the selection of the desired image region. In steps 11 and 12, the customer may select a desired date and time for the images and may submit the order. In steps J1 and J2, the customer's order may be loaded into a computer database. In steps K1 and K2, the customer's order may be analyzed by an algorithm that may determine the imaging opportunities which satisfy the customers order. The algorithm may evaluate the satellite orbits and may generate a list containing possible image times that are close to the imaging time in the customer's order.

In step L, for Earth images, a computer algorithm may determine image quality attributes including the viewing angle, resolution, and lighting conditions for the imaging times available. In step M, for Earth images, an algorithm may obtain the weather forecasts and cloud cover for the selected region. In step N, for Space images, an algorithm may determine the eclipses and planetary phases that may affect image opportunities or quality. In step O, the customer may be presented with the options for imaging dates, times, and details of expected image quality attributes. In step P, the customer may accept or reject the options presented. When options may be rejected, additional options may be presented by returning to step O. In step Q, the customer may select an image option and submit the image order. In step R, a computer may confirm the payment option selected in step B. In step S, the free image orders may be accepted. Non-selected options may be canceled. The customer may proceed to step U. In step T, for paid imaging, the selected image options may be held available and a page of payment options may be presented to the customer. The customer may proceed to step V. In step U, for free imaging, the customer may receive a certificate describing their image order. The customer may print or save the certificate. The customer may proceed to step Z. In step V, for paid imaging, the customer may select a payment method and may submit the order. The customer may proceed to step W. In step W, the customer may be provided with a receipt and details of the order.

For paid imaging, the customer may proceed to step X. In step X, the customer may choose to continue ordering. If the customer chooses not to continue ordering, then the customer may proceed to step Z. If the customer chooses to continue ordering, then the customer may proceed to step Y. In step Y, the customer may choose from one of the current options. If the customer wishes to choose one of the current options, the customer may be returned to step O. If the customer wishes to be presented with new options, the customer may be returned to step C1. In step Z, an algorithm may convert the customer order into a satellite command and may send it to a satellite operations computer. In step AA, the satellite operations computer may determine which ground station may transmit the image control command and may send a command to the ground station. In step AB, when the satellite may pass over the ground station, the imaging control command may be transmitted by radio to the satellite. In step AC, the satellite may execute the command, may record the image, and may transmit the image and other data to a ground station. In step AD, the ground station computer may deliver the image and associated image attributes data to a database server. In step AE, the customer may be instructed to retrieve the image(s) from a website. In step AF, the customer may use the image and other specification data to incorporate images into their own databases or image collections. In step AG, the customer may go to a web page to check order status, store, browse, and share images with other customers.

In addition, the system according to the present invention may require internet access, personal computers or other devices with internet access, stationary computers, databases, computer algorithms (to automate matching satellites and ground stations to customer inputs, translate customer inputs into satellite pointing coordinates, manage commanding, retrieval, storage, and delivery of image data), many existing or new imaging satellites in space, radio ground stations with antenna pointing systems, computer databases, rockets capable of launching appropriate satellites into appropriate orbits, and a system for management of the operation and collection of payments.

FIGS. 1, 2, and 3 show a sequence of steps with reference numbers 1-5 for the method of the present invention, according to one embodiment. The steps 1-5 may have several possible sequences. In one embodiment, 1 (step A) may be followed by 2 (Step E). In one embodiment, 4 (steps 11 or 12), may be followed by 3 (Step F1 or F2). In addition, the customers may be presented with options for browsing archived image examples, as in 5 (Step AG), at any time.

In one embodiment, the customer may be provided with examples to aid the customer in specifying orders for better results. In one embodiment, the customer may store the images for future use. In one embodiment, the images may be reordered by reusing previous order data or using a predetermined schedule. In one embodiment, the images may be reordered by using an autonomous ordering algorithm. In one embodiment, the autonomous ordering algorithm may identify imaging opportunities, collect and deliver images, without the customer placing an order at all. In one embodiment, the method may automatically identify the customer's location using existing internet location finding abilities and may automatically provide imaging options to the customer based on the location identified. In one embodiment, the customer may call by telephone or radio to place an order using a service that may take verbal orders.

The customer may select simple inputs through web pages to place an order. To enable this, the invention may include many computer programs and databases through a central computer algorithm. One of the databases may contain the orbit definition of each satellite. The algorithm may match the satellite ground tracks to the customers image request, identifying times when images may be recorded, obtaining view angles, and expected lighting conditions at the time of imaging. A computer may also evaluate forecasted cloud cover. The imaging time options and associated data may be delivered to the customer through a web browser. The customer may select an imaging option which then may be committed to a database for satellite commanding. The customer's ground coordinates and time may be converted into pointing coordinates and time for the satellite. An automatic algorithm may determine when the identified satellite may be over a ground station and may send the imaging command to the satellite which may proceed with operations until it arrives at the correct orbit coordinates and time to record the image. The satellites may use autonomous controls to point their imaging telescopes to the ground (or space) targets. A charge-coupled device sensor (CCD sensor) may record the image and may transfer the image to an electronic memory on the satellite. When the satellite passes over a ground station again, the satellite may transmit the image data to the ground station. The ground data storage and delivery system may store the image data and may send an e-mail to notify the customer of the image arrival. The e-mail may contain a hyperlink to a website where the customer may retrieve their image.

The invention may also be used for global communications, such as secure file transfers to and from locations whether connected to the internet or not. The latter is possible by use of a portable, low-cost ground station. Multiple satellites may be used to perform co-added low light imaging, three-dimensional imaging, and photometry studies. The system may be useful for studying visible changes in the earth or space environments, and in military applications for observing changing threats over short or long time frames. In addition, the method and system of the present invention may be used for disaster management, real estate business, land and sea management, and law enforcement at all levels.

The invention may produce and deliver new images of earth and space within minutes to hours of the time they were requested. Compared to current systems, the present invention may allow the consumer to place orders in minutes, receive images in a matter of hours, and pay far less, or pay nothing.

The present invention will use a large number of low-cost orbiting satellites with a user-friendly ordering tool accessible through the internet. The ordering tool, and computer algorithms that support it, automatically handle the complexity of commanding satellites to record images. The user needs only to indicate the region they wish to image and the time the image is to be taken. The present invention will handle all the details of managing the satellite system and ground network. This approach makes it possible to highly increase the quantity of images that can be ordered, making the system accessible to many more users on a daily basis than current systems.

It should be understood, of course, that the foregoing relates to exemplary embodiments of the invention and that modifications may be made without departing from the spirit and scope of the invention as set forth in the following claims.

We claim:

1. A method for consumer-direct requesting of images from an Earth-orbiting satellite system comprising:
an online Earth map with an image location selection tool;
an online space map with an image location selection tool;
consumer selection of an image location from a map;
consumer specification of a desired imaging time;
using a computer algorithm to match Earth or space coordinates of the selected image with the ground track of at least one satellite;
generating and providing options to the consumer with image quality attributes;
placing an order at the consumer's request;
sending the order to a computer database;
generating Earth or space pointing coordinates for satellite(s) selected to record the image;
automatically selecting a ground station to command the selected satellite(s);
automatically commanding the selected satellite through the selected ground station(s);
automatically recording the selected image with a selected satellite;
automatically transmitting the selected image from the satellite to a ground station;
storing the selected image into a computer database;
retrieving the selected image from the computer database; and
delivering the selected image to the consumer.
